(19) United States
(12) Patent Application Publication
(10) Pub. No.: US 2008/0224342 A1
(43) Pub. Date: Sep. 18, 2008

(54) Method For Forming Two-Tone Parts For Automotive Interior Applications

(75) Inventor: James D. DOWD, Farmington Hills, MI (US)

Correspondence Address: GROSSMAN, TUCKER, PERREAULT & PFLEGER, PLLC, 55 SOUTH COMMERICAL STREET, MANCHESTER, NH, 03101, US

(73) Assignee: COLLINS & AIKMAN PRODUCTS CO., Southfield, MI (US)

(21) Appl. No.: 11/872,627

(22) Filed: Oct. 15, 2007

Related U.S. Application Data
(63) Continuation of application No. PCT/US06/14262, filed on Apr. 13, 2006.
(60) Provisional application No. 60/670,721, filed on Apr. 13, 2005.

(51) Int. Cl. B29C 39/12; B29C 44/06; B29C 59/02; B29C 65/00

(52) U.S. Cl. 264/45.3; 264/46.6; 264/245; 425/385; 264/139

(57) ABSTRACT

The present invention is directed at an improved method for forming two-tone trim panels for automobiles and the like, wherein the color demarcation line between color regions of the panel skin may be hidden in a narrow groove or joint. The groove in the formed skin may be formed by the expansion pressure of foam conforming the skin to a narrow projection in a foam mold. Alternatively, a narrow groove may be formed by skiving or embossing along the color demarcation line.

### CROSS REFERENCE TO RELATED APPLICATIONS

The present application is a continuation of International Application No. PCT/US2006/014262 filed Apr. 13, 2006 and published Oct. 19, 2006 as International Publication No. WO 2006/110909, designating the United States, and which claims the benefit of the filing date of U.S. Provisional Application Ser. No. 60/670,721, filed Apr. 13, 2005, the teachings of which are incorporated herein by reference.

### FIELD OF THE INVENTION

The present invention pertains to a method of forming two-tone parts particularly suitable for automotive interior applications. More specifically, the present invention relates to the preparation of a two-tone or multi-colored part, by utilizing a material of a first color in combination with a material of a different color to form an outer skin, wherein a groove in the surface of the skin is used to separate the two colors and wherein that groove is substantially narrowed during the subsequent foaming process. In alternate embodiments, the narrow groove may be provided by skiving a groove into the skin along the mating line of the two colors with a knife, or by embossing a groove into the surface of the skin, along the mating line of the two colors, with a heated die.

### BACKGROUND OF THE INVENTION

Typically, panels on the interior of an automobile comprise an outer skin, a supportive substrate, and a polyurethane foam layer sandwiched between the skin and the substrate. Because the outer skin is the portion that is the most visible to the consumer, it must be aesthetically pleasing, durable, and functional. One method for improving the aesthetic appeal of trim panels is the use of outer skins having multiple colors, textures or materials contained within a single panel, a so-called multi-colored or two-tone effect.

There are currently many prominent techniques used in the automotive industry to produce trim panels having a two-tone appearance. One method consists of initially manufacturing the entire skin having a single first color using conventional techniques, such as dry casting, blow molding or vacuum forming. After the skin has been formed and removed from the mold, a paint mask is applied along a break line or styling feature to mask off the portion of the skin that is desired to be the first color. Once the skin has been appropriately masked the exposed portion of the skin is painted a second color. While this manufacturing method allows the skin to be molded using standard molding equipment, any painting defects, such as bleed-through along the mask line, or misalignment of the mask, will result in a defective part that must be discarded. Also, the skin beneath the paint is of a different color than the paint, therefore, any full thickness damage to the paint will reveal the underlying skin of a different color. This is generally considered to be unacceptable to automobile manufacturers.

A second method of producing a two-tone skin is a reactive, preferably urethane, spray method. In the urethane spray method, a skin tool is masked off such that the region of the tool corresponding to desired region of the first color remains exposed. Again, a surface feature such as a projection or ridge is provided to engage a mask and limit overspray. With the skin tool masked off in this manner a urethane precursor liquid, comprising an isocyanate and a polyol, of the first desired color is sprayed and reactively cured. The mask is then removed exposing the remainder of the tool. Next, the entire tool, including the previously sprayed urethane layer, is sprayed with a urethane precursor liquid of the second desired color. While the process used does not require a great deal of specialized and/or expensive equipment, any waste or scrap urethane pieces are not recyclable. Further, the liquid urethanes may contain hazardous components, resulting in environmental and health concerns. Alternately, the second color may be provided by casting a thermoplastic powder, such as a thermoplastic urethane or polyvinyl chloride composition, onto the surface of the shell tool and over at least a portion of the sprayed urethane layer of the first color.

A third method of making two-tone skins for trim panels is via dry casting using a single powder box. By this method a conventional dry casting tool, preferably a grained electroform, is used in conjunction with a single powder box containing two colors of powder separated by a divider. The top edge of the divider is provided with a gasket that seals against a ridge or projection in the tool surface during casting, therein allowing a skin to be simultaneously cast with regions of different colors. After the skin has been cast, the exposed mold surface resulting from the gasket sealing against the projection in the mold surface is then filled by spraying the region with a powder of one of the colors. Unfortunately, the line resulting from the gasket is seldom as crisp as demanded by the manufacturers, often resulting in a blurred and wavy or uneven transition between colors. This defect usually requires that one of the color regions be covered and painted to produce the desired crispness of the transition line between colors.

Another method commonly used to produce skins having a two-tone appearance is a dry casting method using two powder boxes. According to this method, a standard dry casting, preferably electroformed, tool is used, wherein the first region of the tool is cast in a first color using a first powder box. The first powder box is equipped with a gasket corresponding to, preferably, a projection or ridge in the mold surface along the perimeter of the region to be formed in the first color. When the powder is cast in the mold using the first powder box, a layer of the first color is formed. Subsequently, a second powder box containing a resin having a second color is used to cast powder over the entire mold, therein also over-casting the region having the first color. This method obviates the need to spray powder on the gasket line, as is required when a single powder box is used, but the problem of blurred transition lines formed by the gasket must still be dealt with.

In all of the aforementioned processes for forming two-tone plastic trim panel skins, the ridge or projection along the mold surface that mates with the powder box gasket or paint mask may provide some hiding of the demarcation line between the colors if the mask edge is placed near or at the top of the ridge (bottom of the groove formed in the shell). However, the groove so formed in the surface of the skin is generally much wider than deep and thus doesn't hide the color demarcation line well.

Other methods for producing multi-colored or two-tone parts include separately vacuum forming or casting skins of different colors and then welding, gluing or in some fashion mechanically or chemically attaching the two skins of different colors along a joint line to form the two-tone skin which is subsequently foamed-in-place to form the multicolored panel. U.S. Pat. Nos. 4,861,543; 5,705,005; 5,773,115 and 6,318,783 all assigned to the assignee of the present invention and herein included by reference are examples of these methods. In addition, U.S. application Ser. No. 10/501,099, also commonly assigned to the assignee of the present invention and herein included by reference, is directed at a joint for a trim panel having two different coverings, wherein a connector platform or appliqué covers the joint line formed along the common edge of the two coverings, which may be of different colors. These methods of separately forming two different colored skins and subsequently joining them together are quite costly as two separate skin portions must be formed and handled and then joined together.

The problem to be solved by the present invention is that with many skin tool forming processes there is a practical limit to how thin a ridge or narrow a groove may be formed in the tool due to the limitations in the process that forms the mold or tool. Generally, a ridge or projection formed on the surface of a skin tool, particularly an electroformed nickel, is limited to a height of about one half the width (H/W=½) in order to allow for plating of an adequate thickness to ensure that a durable tool will be formed. In other words, a 2 mm. wide projection may only be 1 mm. high. This translates into a groove in the surface of the resulting multi-colored skin being 2 mm. wide and only 1 mm. deep, hardly robust for hiding the color demarcation line. Thus a wavy or blurred transition line may be visible to the consumer in the groove on the face of the trim panel. Even with vacuum forming or blow molding processes, there is a practical limit as to how sharp a feature may be formed on the surface of the skin forming mold to act as a groove in the skin to hide a color demarcation line without weakening the skin to a point where it is fragile to handle or may be penetrated during the subsequent foam-in-place process.

It would therefore be desirable to have a method for producing a trim panel skin having multiple colors in a single molding that uses existing equipment and that produces the appearance of a clearly defined aesthetic color transition or demarcation between color regions. In accordance with such method, it would be desirable to have a method for producing such two-tone skins such that the transition line between the two colors is essentially hidden from view by placing it at or near the bottom of a narrow groove in the surface of the panel. It is a further object of the present invention to provide a groove for hiding the color demarcation line which has a width ratio to height of 1 to 1 or less.

### SUMMARY OF THE INVENTION

In an exemplary embodiment, the present invention is directed to a method for making a trim panel including a plurality of colors comprising the steps of providing a first skin portion of a first color, the first skin portion having an edge which is capable of forming a line of color demarcation. This may be followed by providing a second skin portion of a color different from the first color, the second skin portion having an edge which is bonded to the first portion edge to form the line of color demarcation. The bonding of the first skin portion and the second skin portion form a trim panel skin having a front surface and a back surface wherein the line of demarcation may be disposed in a groove formed in the front surface of the trim panel skin, the groove in the skin having a width of “W₁”. This may be followed by providing a foam mold having a cavity surface for foaming-in-place the trim panel skin, wherein the mold includes a projection extending from the cavity surface in a configuration which may be generally complementary to the groove, wherein the projection has a width “W₂” wherein “W₂” is less than “W₁”. This may be followed by foaming the skin in place in the mold by applying foam precursors to the back surface of the skin thereby forcing the width “W₁” of the groove to decrease.

In a second exemplary embodiment the present invention is directed at a method for making a trim panel skin including a plurality of colors, comprising the steps of providing a first skin portion of a first color, the first skin portion having an edge capable of forming a line of color demarcation. This is followed by providing a second skin portion of a color different from said first color, the second skin portion having an edge bonded to and overlying the first skin portion edge to form the line of color demarcation. This may then be followed by exposing the skin along the line to a knife capable of cutting, skiving or removing portions of the first and second skin portions to provide a groove in the skin along said line of color demarcation.

In a third exemplary embodiment, the present invention relates to a skin forming tool for providing a joint line in a trim panel skin having two color regions, the regions bonded at a common edge to form a joint line, the tool having a surface comprising a first tool portion for forming the first color region and a second tool portion for forming the second color region. The portions may be separated by a projection in the surface of the tool corresponding to the joint line in the skin, wherein the second tool portion is larger in length and width dimensions than the second color region by an amount “X” that is substantially equal to the shrinkage of the skin as the skin is formed. In addition, the length dimension of the first tool portion adjacent to the joint line may be larger in dimension than the first color region length by an amount “X”, wherein the width dimension of the first tool portion generally normal to the joint line is “Y” and “Y” is greater than “X”.

### BRIEF DESCRIPTION OF THE DRAWINGS

These and other features, aspects, and advantages of the present invention will be better understood when the following Detailed Description is read with reference to the accompanying drawings wherein:

FIG. 1 is a perspective view of an exemplary trim panel for a door of a vehicle illustrating two different color regions separated by a joint line.

FIG. 2 is an enlarged sectional view of the exemplary trim panel of FIG. 1 taken through the area of the joint line between the color regions.

FIG. 3 is a sectional view of the joint line of FIG. 1 as the first color region is being formed in a typical shell or skin forming tool.

FIG. 4 is a sectional view of the joint line of FIG. 1 after the mask is removed and the second color region has been formed.

FIG. 5 is a sectional view of the joint line of FIG. 1 residing in a foam mold being foamed in place.

FIG. 6 is an enlarged sectional view of a joint line, according to the present invention, prior to foaming in place.

FIG. 7 is an enlarged sectional view of a joint line, according to the present invention, after foaming in place.

FIG. 8 is a perspective view illustrating two different expansion factors applied to two different color regions of a skin tool for a trim panel for a door of a vehicle.

FIGS. 9A and 9B are enlarged sectional views of a joint line, according to another aspect of the present invention.

FIGS. 10A and 10B are enlarged sectional views of a joint line, according to another embodiment of the present invention.

FIGS. 11A and 11B are enlarged sectional views of a joint line, according to another embodiment of the present invention.

### DESCRIPTION OF THE INVENTION

A method for making a multi-colored molded plastic trim panel having an improved demarcation line between colors on the two-toned surface may initially comprise the steps of providing a mold having an inner surface and covering said mold surface with a mask, wherein said mask leaves a portion of said inner surface exposed. The mask preferably mates with and engages a projection or ridge formed on the surface of the mold to reduce color contamination between the colors as they are applied to the mold surface. This may be followed by the application of a liquid or powder comprising a first polymer material within said exposed portion and at least partially solidifying said liquid or powder comprising said first polymer material on said exposed portion creating a first color region. The mask is then removed, followed by the application of a second particulate or liquid polymer comprising a second material to the remainder of the mold surface (previously covered by the mask) to form a second color region. The second material may also cover a portion of the partially solidified first polymer and thereby bond together the first and second polymer materials in that overlap area. The first and second polymer materials may be either a thermoplastic or thermoset material.

The projection or ridge on the mold surface may form a corresponding groove in the surface of the resulting two-toned skin which has width and height dimensions that may be controlled by the processes used to manufacture the mold. To provide a narrower groove in the finished trim panel to better hide the color demarcation line in the groove, when the aforementioned skin is foamed, the corresponding projection or ridge in the foam mold, which locates the two-tone groove, may be made narrower and deeper to allow the expansion pressure of the foam to close up the groove to a narrower dimension. In order that this narrowing of the groove may occur without other visual defects becoming evident along the radii along each side of the groove due to the expansion and pressure of the foam, a different shrinkage factor may be built into the two different color regions of the shell mold. This may allow some additional skin material of one of the colors to be available to take up some of the space of the original groove.

In alternate embodiments, the two-tone demarcation line may be formed on a flat or slightly depressed surface using a process similar to the above, and then a narrow groove may either be cut, using a heated or ultrasonic knife, or embossed using a heated die to encompass the color demarcation line.

Using any of these methods, an improved appearance for a multi-colored trim panel is provided by hiding the color demarcation line between regions of different colors in a narrow groove.

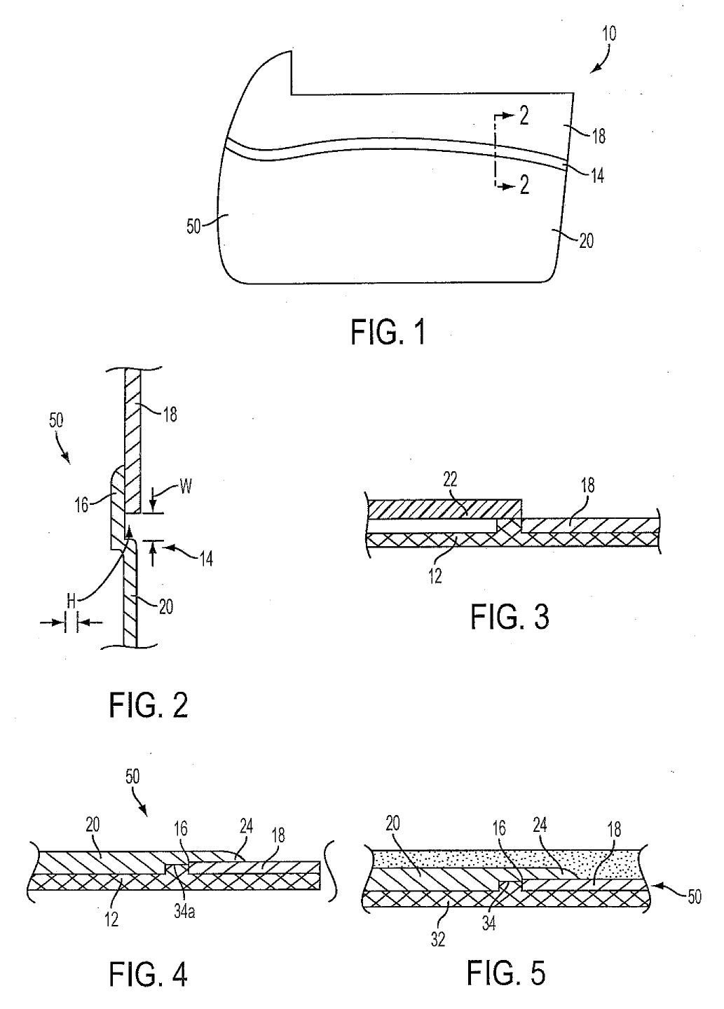

With reference to the figures, a plastic article having multiple colors, textures, or materials integrated into a single skin, may be formed into a trim panel for the interior of a vehicle, such as a two-tone door panel shown at 10 in FIG. 1. The panel 10 comprises a skin 50 having a first color region 18 and a second color region 20 connected along a joint or common edge 14. The joint 14 generally comprises a groove in the panel (shown greatly enlarged for purposes of clarity herein) so that the color demarcation line between regions may be hidden in a depressed area of the groove (along the sides or at the bottom).

FIG. 2 is an enlarged sectional view of the skin 50 taken through the joint line of FIG. 1 in the direction of arrows 2-2. The joint 14 generally has a depth or height dimension H of about one half that of its width W due to the limitations of the processes used to form the tool from which the skin 50, comprised of two color regions, is made. This allows that the colored demarcation line 16 may be visible in the groove or joint 14 to an occupant in the vehicle.

The typical tool for forming a plastic skin comprised of two color regions (or two-tone) generally comprises an electro-formed tool 12, a sectional view of a portion of which is shown in FIG. 3, which may be heated from the backside by forced hot air, infrared heating or other conventional methods. Prior to the start of the skin making process, the skin tool 12 may be preheated. The mold pre-heat time and temperature may be dependent upon the polymer materials to be used in the casting and the desired thickness of the final part. The parameters required to form an article having the desired characteristics will be readily evident to one having ordinary skill in the art.

Once the tool 12 has been preheated, a mask 22, as illustrated in section in FIG. 3, may be applied to the surface of the tool. The mask 22 applied to the surface of the tool leaves a first portion of the surface of the tool exposed and may define a first layer or color region 18 on the surface of the tool that is to be formed of the first material. The first layer or color region 18 may correspond to regions of the final skin that are to be formed having a first character as a first color that may be different than the portion of the skin corresponding to the region of the mold 12 that is covered by the mask 22. The difference in character of the first layer or color region 18 may include differences in color, material, texture, etc. An example of this difference in character is a region of a trim panel that is to include a color that is different than the remainder of the trim panel. Additionally, logos, raised regions, and various other stylistic features may be formed by or included in the first color region.

With the mask 22 in place, a liquid comprising a first polymer material may be applied to form the exposed first layer or color region 18. The liquid material may preferably be applied to the tool to form the first layer region 18 by a spraying technique. Alternatively, the liquid material may be applied to form the first layer region 18 by other conventional techniques such as liquid casting, wherein the first liquid polymer formulation is supplied to the surface of the tool by a conventional liquid casting apparatus. Further, the first polymer material may be in a powder or particulate form and sprayed or cast onto the surface of the skin tool not covered by the mask 22.

In the broad context of the present invention, it is not limited to two-tone plastic articles, and more generally allows for the casting and formation of two different polymer resins of different colors on the inner surface of a mold, such that the polymer resins are bonded together and joined along an edge thereof. By reference to the fact that the polymer resins are bonded together, it should be appreciated that such bonding relates to either a chemical or physical bond between the resins. For example, in those situations wherein one of the resins is a thermoset resin, which will solidify upon cross-linking, it will be understood that the bonding between the indicated resins may actually result in a chemical bond between the two polymer resin surfaces. Alternatively, in the case of thermoplastic type resins, when such resins are molded and solidified, although no chemical reaction occurs, as in the case of thermoset resins, the resins may nonetheless bond together, simply as a consequence of the physical molding process.

As it is used herein, the liquid material may include thermoplastic or thermoset polymer formulations in which the polymer itself may be in liquid form, such as a thermosetting polyurethane comprising liquid reactant components, or a polymer formulation in which a polymer resin is in solution or in a liquid continuous matrix dispersion, including a solvent or an aqueous dispersion. Exemplary liquid plastic materials may include plastisols in which a finely divided plastic resin is dispersed in a liquid plasticizer continuous phase. Alternatively, hydrosols may be employed in which a finely divided plastic resin is dispersed in an aqueous continuous phase. Furthermore, the use of organosols, i.e., a plastic resin in admixture with a volatile organic solvent, are also contemplated as suitable for use with the present invention. Finally, it will be appreciated that the polymer material may additionally include any additives or processing aids that may be deemed desirable, such as plasticizers, colorants, stabilizers, etc.

In accordance with spraying or casting of the first layer or color region 18, it has been found that the thickness of the first layer 18 may preferably be about 0.010-0.060 inches, and may vary within said range by 0.001″ increments. However, it has been found that preferably, the first layer may be of a thickness of about 0.015″ if it will be fully overcast by the second layer and about 0.040″ if the overcast portion is only in the immediate area of the joint line 14. (See FIG. 4.)

Once the liquid or particulate material has been applied to form the first layer or color region 18, the polymer layer resulting therefrom must be sufficiently solidified such that the first polymer material will maintain its shape on the tool surface 12. After the first polymer material has sufficiently solidified, the mask 22 may be removed from the tool surface 12, therein also removing any of the first plastic material that was applied outside of the first layer color region 18. As illustrated in FIG. 4, the removal of the mask 14 from the tool surface 12 exposes the remainder of the tool surface not having deposited thereon a first layer 18, and a second layer of a second color to form a second color region 20 may then be applied to that exposed surface.

Alternatively, the mask may be removed after the liquid material is applied. Under these circumstances, it has been found preferable to wait until that point in time wherein the first layer 18, although partially solidified, may be sufficiently elevated in viscosity such that its shape on the tool surface will be adequately maintained until that point at which the second polymer material is applied, as noted below. Those skilled in the art will therefore recognize and may refer to such elevated level of viscosity as a partial-cure, or partial-set, indicating that solidification, while in progress, is not yet complete. Along such lines, partial solidification may be due to such factors as an increase in cross-linking, as applied to thermoset materials. Accordingly, in a thermoset material, as cross-linking proceeds, viscosity increases, the material approaches solidification, and cross-linking may therefore be relied upon to maintain the shape of the first layer on the tool surface. As applied to thermoplastic materials, partial solidification is achieved when the polymer material is below its melting point or Tm. Continual cooling therein may result in an increase in solid characteristics, until such time as the glass transition point or Tg of the material may be reached, at which point those skilled in the art will recognize that the material has in general reached it highest level of rigidity.

Accordingly, within the broad scope of the invention, and as applied to thermoplastic material, the first layer of polymer material may be preferably cooled to a temperature between Tg and Tm, as well as those temperatures at or below Tg, prior to application of the second polymer material to the mold surface, as herein described. Furthermore, those skilled in the art will recognize that values of Tg and Tm of plastic materials may be conveniently determined by reference to the available literature concerning polymeric resins.

Accordingly, after the mask 22 has been removed, a second polymer material may be applied to the tool surface 12. The second polymer material may be preferably applied to the tool surface using a conventional dry casting charge box. A charge box (not shown) containing the second polymer material may be affixed to the mold, wherein the mold and the charge box may be rotated to evenly distribute the second polymer material on the tool surface 12. Preferably the first layer 18 is overcast by the second polymer material resulting in a second color region 20 and an overcast layer 24, as illustrated in FIG. 4.

In addition to the above, it should be noted that the charge box herein may be configured to include a gasketed divider such that when the second layer 20 is cast only a portion of the first layer 18 is overcast. Accordingly, it may be appreciated that when the second layer is to be cast in the tooling illustrated in FIG. 4, only a portion of the first layer 18 will be overcast. The second polymer material may comprise any form of particulate, including what is commonly termed as powders, beads, pellets, minibeads, microspheres, etc. Preferably the second polymer material comprises a thermoplastic or thermoset resin, and more preferably comprises PVC, PU or a PVC alloy composition such as disclosed in U.S. Pat. Nos. 5,525,274; 5,525,284 and 6,410,141. Alternately, the second plastic material may comprise a material including, but not limited to, other vinyls or vinyl copolymers, urethanes (e.g. PU or TPU), olefins (e.g. polyethylene, polypropylene, thermoplastic olefin materials), polyester materials, styrene based materials (e.g., ABS, ASA), as well as thermoplastic and thermoset elastomers.

Accordingly, it can be appreciated that by practice of the method herein, the use of a mask to seal within the tooling to form a two-tone color line 16 requires good conformability of the mask 22 to the surface of the tool 12 along the intended joint line 14 to prevent overspray or color transfer to the masked portion of the tool 12. It has been found that improved sealing of the joint line by the mask may be provided when the mask 22 comprises a magnetic material or may be magnetized, say by an electromagnet. In this manner, the mask 22 may be made somewhat flexible and may conform to the tool surface at the joint line due to the magnetic attraction to the tool 12.

Once the second layer 20 has been sprayed or cast, it may be fused or cured by applying heat to the back surface of the tool 12. Subsequently, cooling may be applied to the tool 12 to allow the skin 50 comprising the two color regions 18, 20 to be removed from the skin tool 12. The skin 50 may then be transferred to a mold for foaming-in-place. In the foam mold 32, a section of which is shown in FIG. 5, the skin 50 conforms to the surface of the mold 32 and foam precursors expand to form a two-tone trim panel 10.

As will be appreciated, the width of the groove or joint 14 formed in the skin 50 between color regions 18 and 20 remains of the same dimensions as when formed in the skin tool 12, as a ridge or projection 34 of corresponding dimensions is present in the foam tool 32 to stabilize the skin 50 during the foam expansion process. Thus, the width to height ratio of about 2 to 1 is maintained and the color demarcation line 16 may be visible at or near the bottom of the groove or joint 14.

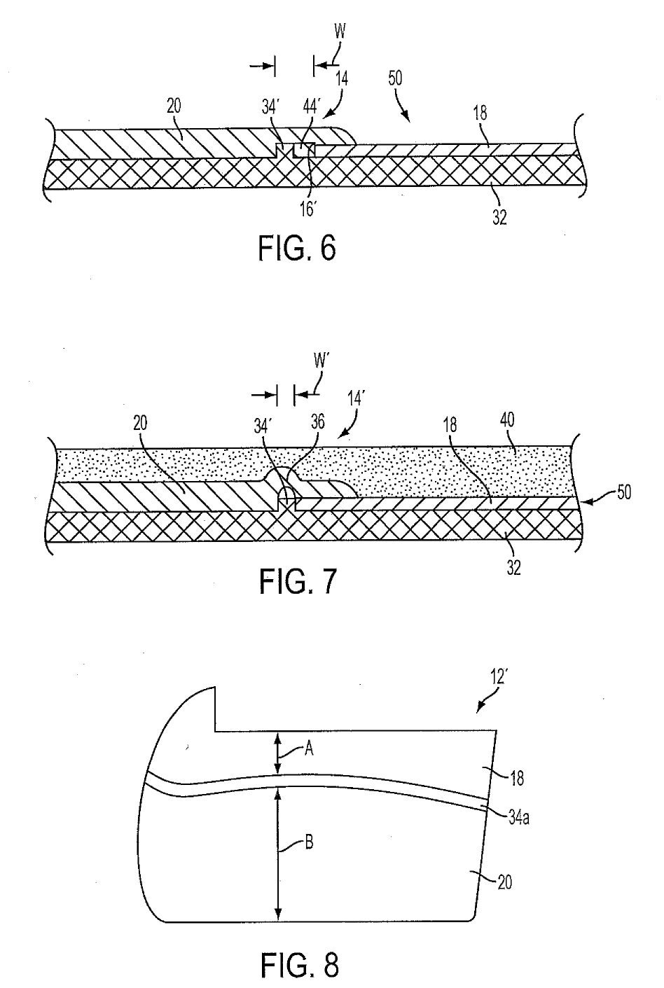

The present invention is directed at providing a narrower groove or joint 14 in the skin 50 which makes the demarcation line 16 at the base of the groove more difficult to be seen by vehicle occupants. This is accomplished in a first embodiment as illustrated in FIGS. 6 and 7.

FIG. 6 illustrates the skin 50 placed in a foam mold 32 in which a narrower surface feature or ridge 34′ (compared to FIG. 5) projects from the surface of the mold to locate the skin. At this point the joint 14 in the skin 50 may have dimensions of width to height of 2 to 1, as indicated by W, as the skin 50 was formed. A space 44 then exists between the inside of the joint 14 in the skin 50 and mold feature or ridge 34′.

FIG. 7 illustrates how a narrower groove may be formed in the trim panel by allowing the pressure of the expanding foam 40 to force the skin 50 to conform to ridge 34′, resulting in a narrower joint 14 of width W′. Preferably, this joint 14′ has a width to height ratio of 1 to 1 or less. For this to occur, the skin 50 may preferably be pliable and able to be elongated slightly to conform to the foam mold. As an assist in forming the skin 50 around narrower ridge 34′ in foam mold 32, vacuum may be applied through holes (not shown) formed in the surface of the foam mold 32 particularly in close proximity to ridge 34′ to locate and retain the skin 50 to ridge 34′ until the foam layer 40 has cured. This process may include some buckling of the skin layer shown at 36 to allow the groove or joint 14′ to be narrowed. If the skin 50 is not extensible, a slight readout or disruption of the edges of the joint 14′ may occur. To prevent such a problem, particularly for skin materials of a higher hardness or modulus, a means for producing a skin 50 having narrower dimensions in the joint area 14′ after solidifying or curing and being removed such from the skin tool 12 has been found.

During the formation of plastic skins from liquid or powder precursors, the skins may solidify on the surface of the mold 12 and may take on the dimensions of the mold surface. Once the skin is removed from the mold, shrinkage may take place. This may be due to thermal changes (cooling) and shrinkage of the material from a melt or otherwise plasticated (flowing) state. It may also result from crystallization of the material, e.g., the crystallization of the polymer chains, which chains are capable of crystallization, as they are cooled and solidified. To compensate for this shrinkage, a skin tool is normally built which has been expanded in surface dimensions by a factor which equals the amount of shrinkage the skin undergoes on cooling and curing. For plastic materials of the type described herein and used as two-tone skins for automotive trim panels, this expansion factor may be in the order of about 0.010 inches/linear inch of surface. Thus, to form a skin having final dimensions of 24 inches by 24 inches the skin casting tool would be built to dimensions of 24.24 inches by 24.24 inches. In the case of a skin having two color regions separated by a joint line or groove, to narrow the groove from 2 mm or 0.080 inches wide to 1 mm or 0.040 inches wide, a different shrink factor may be tooled into one of the color regions to provide less shrinkage, or more material to take up the gap and provide a narrower gap when foamed (FIG. 7). This expansion factor may preferably only be built in to the skin tool direction normal to the joint line to allow the remainder (length) of the skin 50 to be of the desired dimension for the finished trim panel and properly fit the foam mold.

To take up a 1 mm or 0.040 inch gap in a joint line, if the color region 18 in FIG. 1 had a dimension perpendicular to the joint line 14 of 10 inches (to the edge of the panel) then a shrink factor of 0.014 inches may be built into the skin tool portion that will form region 18 instead of 0.010 inches/inch for color region 20. When the skin 50 is formed it may initially have a groove or joint 14 2 mm or 0.080 inches in width, however, after cooling and polymer shrinkage takes place, there may be an additional 0.040 inch of color region 18 in a dimension normal to the joint line that when placed in foam mold 32 may allow the skin 50 to be fitted around feature 34′ and form a 1 mm or 0.040 inch groove without excessive stretching of the skin 50. FIG. 8 illustrates this method schematically, wherein the shell mold 12′ may be expanded by different factors A and B normal to the joint line (or corresponding ridge 34a in the tool) to provide material to allow a narrower groove to be provided in the foaming process. Alternatively, both regions 18 and 20 may be expanded by a larger amount normal to the joint line to provide the additional 0.040 inches of material to fill the joint.

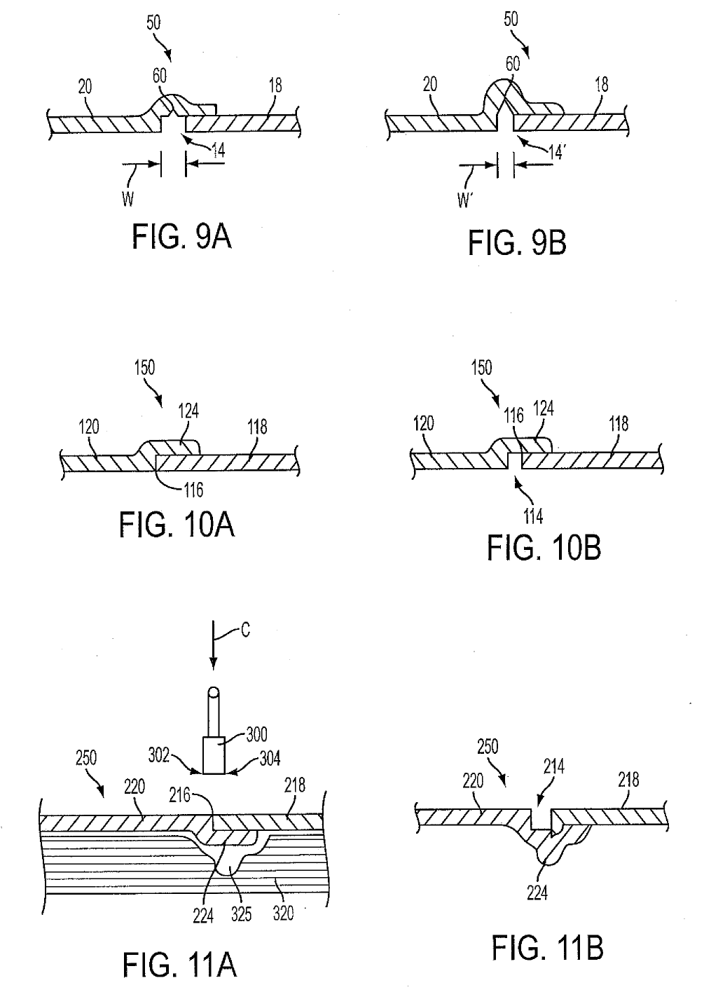

FIGS. 9A and 9B show a sectional view of a joint 14 in a two-tone skin 50 which may include a thinned area or cleavage feature 60 which may allow flexing of the bottom of the groove or joint 14 to take place so that a narrower width dimension W′ may be obtained (see FIG. 9B) with less skin distortion during the foaming process.

In another embodiment of the present invention, to provide a narrow groove or joint or hide a two-tone demarcation line, a skin may be formed preferably without a groove and a narrow groove may be cut into the surface of the skin along the color demarcation line. U.S. Provisional Application Ser. No. 60/573,493 is directed at a method for forming a design in a panel or skin member comprising an outer and an inner layer and is assigned commonly to the assignee of the present invention and included by reference herein in its entirety. A knife which may be heated and/or excited by another source of energy, such as ultrasonics, that may burn, cut, skive or otherwise remove portions of the outer layer may be applied to the outer layer to remove a portion, leaving the inner layer visible.

As shown in FIGS. 10A and 10B to form a narrow groove or joint 114 between color regions 118, 120 in a two-tone skin 150, a skin 150 may be formed without a groove (FIG. 10A) preferably on a relatively flat surface using any of the aforementioned casting, spraying and masking processes. An area of overlap 124 between a first color region 118 and a second color region 120 may be provided to yield a somewhat thickened area in the area of the color demarcation line that is formed by the joining of the two color regions. A narrow bladed knife, heated or otherwise excited to cleanly remove a portion of one layer, may be applied to the thickened area 124 and directed along the demarcation line 116 between color regions 118, 120 to provide a narrow groove (see FIG. 10B) in the skin 150. The demarcation line 116 then may reside at the bottom of the cut groove 114.

In another alternative embodiment of the present invention to provide a narrow groove or joint to hide a two-tone demarcation line, a skin may be formed preferably without a groove and a narrow groove may be formed into the surface of the two-tone skin along the color demarcation line using a heated die.

In this embodiment, as shown in FIGS. 11A and 11B, a heated metal die 300 may be applied to a skin 250 including two different color regions 218, 220 formed preferably without a groove using any of the aforementioned casting, spraying and masking processes. An area of overlap 224 may be formed to provide adequate bonding between the color regions along a demarcation line 216.

Once the skin 250, has been stripped from the skin tool it may be transferred to a press where a heated die 300 moving in the direction of the arrow C in FIG. 11A may be forced against the surface of the skin 250 along the color demarcation line 216 to form a narrow groove 214. The heated die may also be excited by other sources of energy, such as ultrasonics, to aid in forming the groove. Preferably, the heated die has relatively sharp edges 302, 304 to form the groove. Additionally it may be preferable to provide a platen 320 for the die located against the backside of the skin 250 in the overspray area 224 to provide resistance to the intrusion of the die and aid in forming the groove by providing a cavity 325 for the backside of the overcast portion 224 to be formed into. FIG. 11B shows a skin 250 including a formed narrow groove 214.

Those skilled in the art will recognize that various modifications of the invention herein are possible, in light of the above description. It is therefore to be understood that within the scope of the appended claims, the invention may be practiced other than as specifically described.

What is claimed is:

1. A method for making a trim panel including a plurality of colors comprising the steps of:
providing a first skin portion of a first color, said first skin portion having an edge which is capable of forming a line of color demarcation;
providing a second skin portion of a color different from said first color, said second skin portion having an edge which is bonded to said first portion edge to form said line of color demarcation, wherein said bonding of said first skin portion and said second skin portion form a trim panel skin having a front surface and a back surface and wherein said line of demarcation is disposed in a groove formed in the front surface of said trim panel skin, said groove in said skin having a width of “W₁”;
providing a foam mold having a cavity surface for foaming-in-place said trim panel skin; wherein said mold includes a projection extending from said cavity surface in a configuration complementary to said groove, wherein said projection has a width “W₂” wherein “W₂” is less than “W₁”; and
foaming said skin in place in said mold by applying foam precursors to the back surface of said skin thereby forcing the width “W₁” of said groove to decrease.

2. The method of claim 1, wherein said first skin portion is formed by casting.

3. The method of claim 1, wherein said first skin portion is formed by spraying.

4. The method of claim 1, wherein said second skin portion is formed by casting.

5. The method of claim 1, wherein said second skin portion is formed by spraying.

6. The method of claim 2, wherein said casting includes applying a particulate to a mold surface.

7. The method claim 1, wherein either of said first skin portion or said second skin portion may be a synthetic fabric material.

8. A method for making a trim panel skin including a plurality of colors, comprising the steps of:
providing a first skin portion of a first color, said first skin portion having an edge capable of forming a line of color demarcation;
providing a second skin portion of a color different from said first color, said second skin portion having an edge bonded to and overlying said first skin portion edge to form said line of color demarcation;
exposing said skin along said line to a knife capable of cutting, skiving or removing portions of said first and second skin portions to provide a groove in said skin along said line of color demarcation.

9. The method of claim 8, wherein said first skin portion is formed by casting.

10. The method of claim 8, wherein said first skin portion is formed by spraying.

11. The method of claim 8, wherein said second skin portion is formed by casting.

12. The method of claim 8, wherein said second skin portion is formed by spraying.

13. The method of claim 9, wherein said casting includes applying a particulate to a mold surface.

14. The method of claim 8, wherein said knife is subjected to one or a combination of heat, mechanical reciprocation or electrical excitation to remove said portions of said first and second skin portions.

15. A method for making a trim panel skin including a plurality of colors, comprising the steps of:
providing a first skin portion of a first color, said first skin portion having an edge capable of forming a line of color demarcation;
providing a second skin portion of a color different from said first color, said second skin portion having an edge bonded to and overlying said first skin portion edge to form said line of color demarcation;
exposing said skin along said line of color demarcation to an embossing die having a shape, said die capable of permanently deforming said skin in said shape to provide a groove in said skin along said line of color demarcation.

16. The method of claim 15, wherein said first skin portion is formed by casting.

17. The method of claim 15, wherein said first skin portion is formed by spraying.

18. The method of claim 15, wherein said second skin portion is formed by casting.

19. The method of claim 15, wherein said second skin portion is formed by spraying.

20. The method of claim 16, wherein said casting includes applying a particulate to a mold surface.

21. The method of claim 15, wherein said die is subjected to one or a combination of heat, mechanical reciprocation or electrical excitation to deform said portion of said first and second skin portions.

22. A skin forming tool for providing a joint line in a trim panel skin having two color regions, said regions bonded at a common edge to form a joint line, said tool having a surface, comprising a first tool portion for forming said first color region and a second tool portion for forming said second color region;
said portions separated by a projection in the surface of said tool corresponding to said joint line in said skin, wherein said second tool portion is larger in length and width dimensions than said second color region by an amount “X”, substantially equal to the shrinkage of said skin as said skin is formed;
wherein the length dimension of said first tool portion adjacent to said joint line is larger in dimension than said first color region length by an amount “X”, and wherein the width dimension of said first tool portion, normal to said joint line, is “Y” and “Y” is greater than “X”.

23. The tool of claim 22, wherein said first and second tool portions separated by said projection comprise a tool of unitary construction.
